(19) United States
(12) Patent Application Publication
(10) Pub. No.: US 2011/0046980 A1
(43) Pub. Date: Feb. 24, 2011

(54) INFORMATION SECURITY FOR RECOVERY BASED SOCIAL NETWORKING

(75) Inventors: David Metzler, Del Mar, CA (US); Rand Pipp, (US); Benjamin Cote, (US); Michael Cremean, (US); Victor Tyrone Lam, (US); Andrew Paxton, (US); Christopher Williams, (US)

Correspondence Address: PROCOPIO, CORY, HARGREAVES & SAVITCH LLP, 525 B STREET, SUITE 2200, SAN DIEGO, CA, 92101, US

(73) Assignee: ONERECOVERY, INC., Del Mar, CA (US)

(21) Appl. No.: 12/831,127

(22) Filed: Jul. 6, 2010

Related U.S. Application Data
(60) Provisional application No. 61/223,257, filed on Jul. 6, 2009.
(60) Provisional application No. 61/223,262, filed on Jul. 6, 2009.
(60) Provisional application No. 61/223,268, filed on Jul. 6, 2009.
(60) Provisional application No. 61/240,128, filed on Sep. 4, 2009.

(51) Int. Cl. G06Q 50/00; G06F 3/01; G06F 17/30

(52) U.S. Cl. 705/3; 715/751; 707/803; 707/E17.044

(57) ABSTRACT

Systems and methods for recovery based social networking are presented. Users of the social network platform can select different groups of individuals that have access to different portions of the content that the user generates through the social networking platform. Private health information can be maintained separately from information generated by the user through the social networking platform. Healthcare professionals can access both private and user generated information in order to support the user's recovery.

### RELATED APPLICATIONS

This application claims the benefit of U.S. Provisional Patent Application Ser. No. 61/223,257, filed Jul. 6, 2009, entitled “USE OF EMOTICONS IN RECOVERING PATIENT SOCIAL NETWORK SITE,” U.S. Provisional Patent Application Ser. No. 61/223,262, FILED Jul. 6, 2009, entitled “CONTROLLING ACCESS IN RECOVERING PATIENT SOCIAL NETWORK SITE,” U.S. Provisional Patent Application Ser. No. 61/223,268, filed Jul. 6, 2009, entitled “GOAL TRACKING IN RECOVERING PATIENT SOCIAL NETWORKING SITE,” and U.S. Provisional Patent Application Ser. No. 61/240,128, filed Sep. 4, 2009, entitled “ANALYSIS OF EVENTS TO DETERMINE PROBABLE OUTCOMES,” which are hereby incorporated by reference in their entirety.

### FIELD OF THE INVENTION

The invention relates to clinical social networks and more particularly to encouraging recovery using social networks.

### BACKGROUND

Treatment outcomes for different conditions depend on many complex factors. One important factor is support from people such as friends, family, and healthcare professionals. In order to provide support to an individual, it may be important for supporters to have information about the status of the individual. This information may include the individual's emotional state or the individual's behavior. For example, it may be important that the supporters know if the individual is taking his medications, exercising, attending meetings, eating well, or performing other activities involved in treatment of the individual's condition. With timely access to this type of information, supporters can improve the treatment outcome of the individual. However, this type of information may be extremely private. Further, this type of information may be protected under laws such as the Health Information Privacy Act.

Thus, there is a need for an improved system where an individual can share critical treatment information with selected supporters and healthcare professionals while securely maintaining privacy.

### SUMMARY

In one aspect, a system for recovery based social networking is provided. The system includes a logon module configured to authorize a user to access a recovery based social network and a content module. The content module is configured to present interactive content to the user, receive input from the user responsive to the interactive content, and store the input from the user. The system also includes a privacy module configured to restrict access to a first portion of the input to a first user selected group.

In another aspect, a method for recovery based social networking is provided. The method includes establishing a communication link with a user device associated with a user, presenting, via the communication link, interactive content to the user device, receiving, via the communication link, input from the user device responsive to the interactive content, storing the input from the user, and restricting access to a first portion of the input to a first user selected group.

In another aspect, a computerized method for supporting addiction recovery is provided. The method includes establishing a communication link with a user device associated with a user, presenting, via the communication link, interactive content to the user device related to recovery from addiction, receiving, via the communication link, non-private health information from the user device comprising the user's interaction with the interactive content, storing the non-private health information in a first database, storing private health information associated with the user in a second database, modifying the interactive content based, at least in part, on the private health information in the second database and the non-private health information from the first database, wherein modifying the interactive content does not expose private health information from the second database, and presenting, via the communication link, the modified interactive content to the user device.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of an example system according to an embodiment;

FIG. 2 is a functional block diagram of an example computer system according to an embodiment;

FIG. 3 is an illustration of emoticons according to an embodiment;

FIG. 4 is a logical block diagram of a determination process according to an embodiment;

FIG. 5 is an illustration of information considered in a determination process according to an embodiment;

FIG. 6 is an illustration of auras according to an embodiment;

FIG. 7 is a logical block diagram of an example system according to an embodiment;

FIG. 8 is an illustration of privacy selection options according to an embodiment;

FIG. 9 is an illustration of goals and goal tracking according to an embodiment;

FIG. 10 is an illustration of the display of achievements according to an embodiment;

FIG. 11 is an illustration of a recovery clock according to an embodiment;

FIG. 12 is a flowchart illustrating a method of using emoticons according to an embodiment; and

FIG. 13 is a flowchart illustrating a method of handling user information according to an embodiment.

### DETAILED DESCRIPTION

After reading this description, it will become apparent to one skilled in the art how to implement the invention in various alternative embodiments and alternative applications. The following description sets forth numerous specific details, such as examples of specific systems, components and methods in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Particular implementations may vary from these exemplary details and still be contemplated to be within the spirit and scope of the present invention.

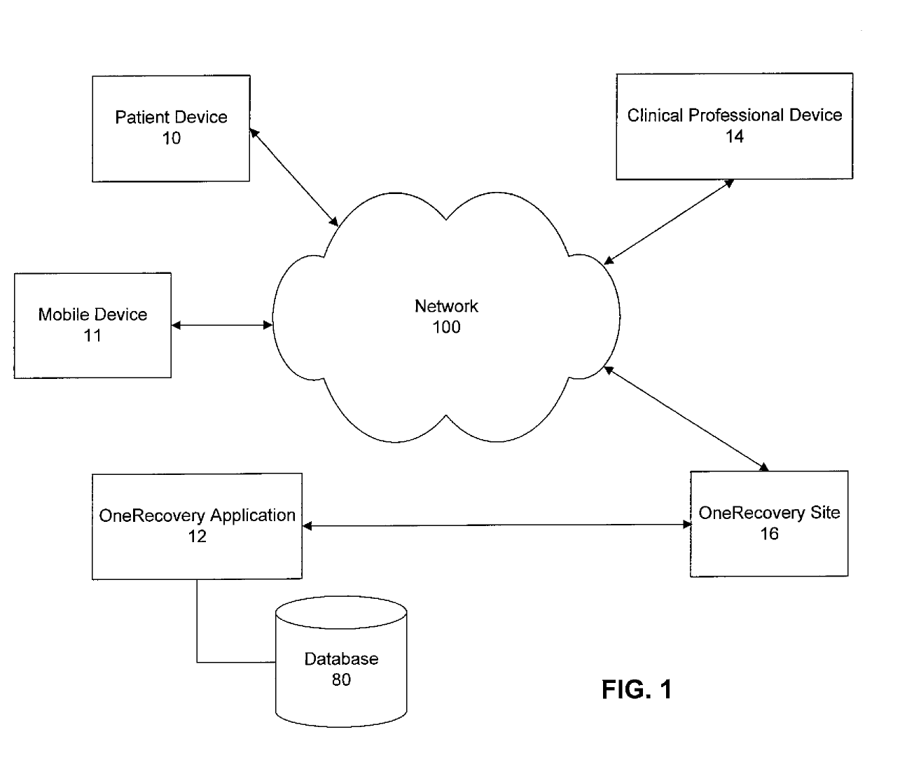

Turning now to FIG. 1, a block diagram representation of a collection of computer systems which can interact with each other by a connection or communication link such as the Internet, local area networks, wide area networks, virtual private networks, and direct connections is shown. A network 100 is shown providing the connection between the devices in FIG. 1. Each of the blocks shown in FIG. 1 represents a computer system, such as a server, a personal computer or other devices capable of communicating over the connections, or a collection of such devices and are generally referred to herein as devices.

In general, block 10 represents a device of a user or member of the system. The device 10 can be any network device. In general, the device 10 is a machine with the ability to communicate with one or more of the computer systems depicted in FIG. 1. For example, in one embodiment, the device 10 is a personal computer with a network connection such as an Internet connection or a wireless device, such as a mobile telephone or a personal digital assistant, with access to a wireless network. Block 11 represents a mobile device capable of wireless data communication. In one embodiment, the user interface for some or all of the functionality described herein may be implemented as an application one the mobile device 11 or as a website accessible via the mobile device 11. Similarly, devices 14 and 16 can be the same types of devices as devices 10 or 11. As shown, block 14 represents a device of a clinical professional and block 16 represents a device (e.g., a web server) hosting a social networking site for recovering patients. The hosting device 16 can receive requests from devices such as the devices 10, 11, and 14. In response to the requests, the hosting device 16 can transfer content to the requesting devices 10, 11, and 14. As described in greater detail below, the content served up by the hosting device 16 can comprise graphical, textual, or audio data corresponding to a social networking service for recovery. The hosting device 16 is in communication with an application device 12 which generates and controls the content hosted by the hosting device 16. For example, as described below, the application device 12 controls access to the various content and user information used in the social networking platform described herein. The application device 12 further controls automated recovery supporting actions described further herein. The application device 12 stores and retrieves data from the database 80 to perform this functionality.

In one operational example, the hosting device 16 receives a login request from the mobile device 11 via the network 100. The hosting device 16 then communicates with the application device 12 which confirms the validity of the login. Application device 12 also determines and provides the content, e.g., status indicators, emoticons, messages, goals, achievements, etc. . . . , that will be returned to the user as described below. The identified content is then served up by the hosting device 16 to the requesting mobile device 11 via the network 100. In one example, the returned content may be displayed in the form of a webpage on the mobile device 11. In another example, the returned content may be displayed as part of an application running on the mobile device 11. The user of the mobile device 11 may then interact with the content through the mobile device 11 and benefit from the recovery support offered by the systems and methods described herein.

For the sake of explanation, the application device 12 and its modules, described below, may be described as performing certain functions such as displaying information to a user or prompting a user for input. It will be appreciated that these terms are used to indicate that the application device 12 and its modules communicate information to devices 10, 11, and 14 through the network 100 which is then displayed by those devices 10, 11, and 14 to their respective users. This is done for the sake of ease of description.

It will be understood that recovering patients and recovery in general are to be broadly interpreted as dealing with any condition such as addiction, infirmity, illness, injuries, or psychological disorders amongst others. Further, the conditions may be chronic or curable. References to addiction recovery should not be interpreted as limiting. In general, the systems and methods herein support changes to behavior that lead to better medical outcomes regardless of the type of condition.

A social network, as used in connection with certain embodiments herein, relies upon a social network service for building online communities of people who share interests and/or activities, or who are interested in exploring the interests and activities of others. Such social network services are web based and provide a variety of ways for users to interact, such as email and instant messaging services.

In general, the social networking service allows users to create a profile for themselves, and can be broken down into two broad categories: internal social networking (“ISN”) and external social networking (“ESN”) sites, such as MySpace, Facebook, etc. Both types can increase the feeling of community among people. An ISN is a closed/private community that consists of a group of people within a company, association, society, education provider and organization or even an “invite only” group created by a user in an ESN. An ESN is open/public and available to all web users to communicate and are designed to attract advertisers. ESN's can be smaller specialized communities (e.g., linked by a single common interest) or they can be large generic social networking sites (e.g., MySpace, Facebook etc).

However, whether specialized or generic there is commonality across the general approach of social networking sites. Users can upload a picture of themselves, create their ‘profile’ and can often be “friends” with other users. In many social networking services, both users must confirm that they are friends before they are linked. Some social networking sites have a “favorites” feature that does not need approval from the other user. However, social networks usually have privacy controls that allow the user to choose who can view their profile or contact them, etc.

Referring back to FIG. 1, in one embodiment, device 16 represents a social networking site for recovering patients. Device 16 provides (serves) web pages which can be visited by patients, clinical or healthcare professionals and others to interact with the system as will be described in more detail below.

According to one aspect, block 12 represents a computer system or device which provides the functionality for the social networking site 16. System 12 may generally be referred to as the platform which provides the functionality described herein. System 12 is in communication with a database 80. Database 80 allows system 12 to store necessary information that system 12 may need to access for performing the back-end functionality. Of course, other configurations of computers can also be used.

In one example, system 12 supports a social network for building one or more online communities of people in recovery from addiction or other conditions and those clinical professionals, medical professionals, friends and loved ones that support the recovery of those patients. The system 12 provides social network services which are web based and can include, for example, a variety of ways for users to interact, such as email and instant messaging services.

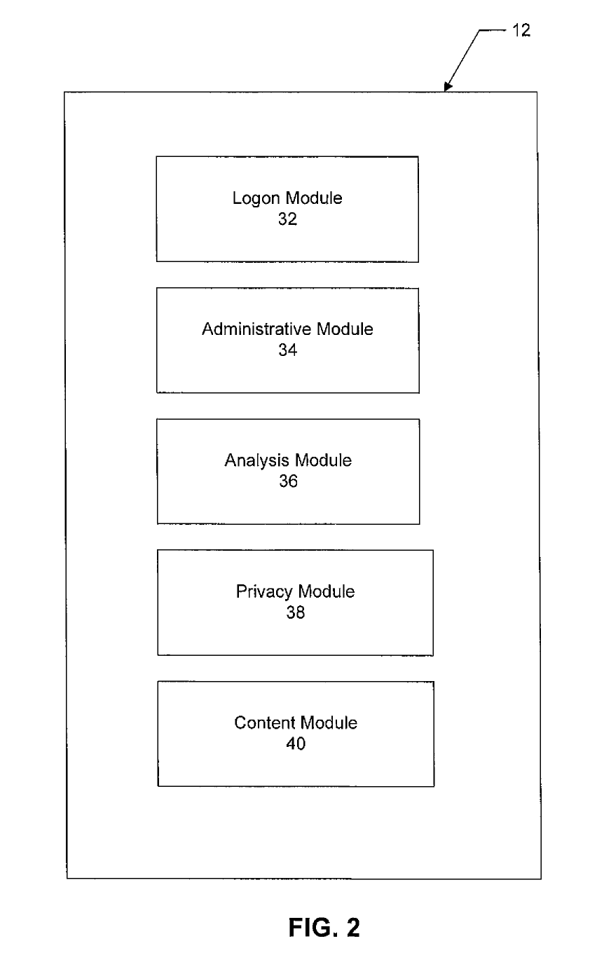

FIG. 2 shows a block diagram representation of the modules or functionality which can be implemented by the system 12. The system 12 may generally be referred to as the platform. It will be appreciated that the functionality described herein is generally performed by the platform and its components described below. In addition, the modules described herein may be collectively referred to as “recovery functionality”. In one embodiment, the modules or functionality implemented by system 12 include a logon module 32, an administrative module 34, an analysis module 36, a privacy module 38 and a content module 40.

According to one aspect, logon module 32 provides the features and tools that allow a user to register for an account and access the account. As used herein, registration refers to the creation of the account. In one embodiment, an account administrator controls, restricts, or approves the user for an account. The account administrator may be affiliated with a treatment center and the user may be a patient or discharged patient of the treatment center/facility. This may ensure that only current and former patients have access to the social network being monitored by the treatment center. The logon module also provides the functionality for verifying login credentials. When a user attempts to login, the logon module 32 verifies that the username and password provided are valid. The logon module 32 accomplishes additional functionality as described below.

The administrative module 34 provides functionality for healthcare professionals to observe and interact with users of the social networking platform. In one embodiment, healthcare professionals associated with respective users are able to observe the activities of their users on the platform. For example, as described below, the platform may store a user's selection of emoticons over time. The administrative module 34 provides the user's healthcare professional with the emoticon history so that the professional can track the status and progress of the user. The administrative module 34 provides additional functionality as described below.

The analysis module 36 provides functionality for automatically determining and performing recovery supporting actions. In general, the phrase recovery supporting actions refers to an action taken by the platform to support or encourage a user's recovery. As described below, this may include, but is not limited to, sending messages to other users or healthcare professionals requesting support for the user, providing the user with an automatically generated message offering support, or providing the user with a supportive message that has previously been generated or selected by the user or by other users. For example, based on the user's selection of a status indicator, such as an emoticon, indicating a depressed emotional state, the analysis module may determine that the user should be supported and may notify a healthcare professional. The analysis module provides additional functionality as described below.

In one embodiment, the privacy module 38 protects the privacy of information that users provide through interaction with the content on the platform. For example, as described below, the privacy module 38 can limit the access of different types of users to different portions of a user's information or content based on the user's preferences. In one embodiment, once the user logs into his account, the user will have access to email, texting, and friends lists, similar to traditional social networking sites. Additionally, the user will have access to other features described below. The privacy module 38 allows the user to subdivide other users into categories, such as care group (people the user is supporting in their recovery), life line (people supporting the user in recovery), family, etc. The privacy module 38 accepts input from the user indicate indicating that members of each category be given different access and communication attributes as described below. For example, the user may indicate to the privacy module 38 that only the user's healthcare provider and lifeline should have access to the user's journal. The privacy module 38 implements the user's preferences by preventing all other users from accessing the user's journal. The privacy module 38 provides additional functionality as described below.

In one embodiment, the content module 40 controls and generates interactive content that is provided to users of the platform. As described above, in one embodiment, the platform presents users with a homepage type interface. The content module 40 controls and generates the material presented to the user on the homepage. The content module 40 provides different types of content including, but not limited to blogs, journals, e-mail, a wall, emoticons, and recovery clocks. The content module 40 receives data from the users who interact with the content and stores the data for use by other modules. The content module 40 provides additional functionality as described below.

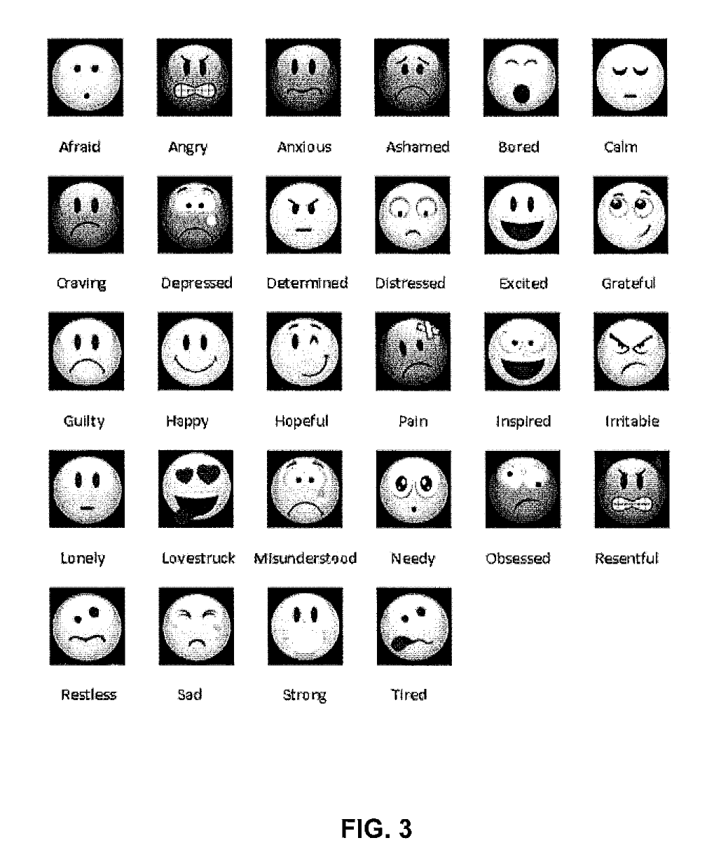

Referring now to FIG. 3, in one embodiment, immediately after logging in, the content module 40 prompts a user to select a status indicator. A status indicator is to be broadly understood as a visual, audio, or textual object that represents information relevant to recovery. For example, for recovery from eating disorders, the status indicators can be textual phrases relating to the number of balanced meals eaten in the last 24 hours. Alternatively, for other conditions, the status indicators can be phrases or images relating to having taken prescribed medications. In another embodiment, the status indicators can be emoticons which represent how the user is feeling. Emoticons, as described herein, may be visual, textual, or sound/speech related. Users may have the option of selection a graphical emoticon, word, phrase, color or image that represents their emotional state. These options may be available once a day, each time the user logs in, or at other intervals. These options may also vary based on the user profile or the condition from which the user is recovering. Emoticons are in common use in texting, IM, email, etc. They are normally used to underline the context of a given line of text. For example, if a user sends a text that says “The band was terrible and the tickets cost me $100” they may tack on an emoticon such as [symbol] indicating that the user is very sad indeed about this. Alternatively, the user may send an email that says “The band was great and I managed to get a free ticket!” and tack on an emoticon such as [symbol] indicating that the user is really delighted with the outcome. There are many different emoticons in text form using a number of characters together, such as XD meaning laugh out loud (X is the eyes being squinted and the D is the mouth, etc).

In one example, when a user is logging on, the content module 40 presents the series of emoticons shown in FIG. 3. The series of emoticons may include, for example: Afraid, Angry, Anxious, Ashamed, Bored, Calm, Craving, Depressed, Determined, Distressed, Excited, Grateful, Guilty Happy, Hopeful, Pain, Inspired, Irritable, Lonely, Love struck, Misunderstood, Needy, Obsessed, Resentful, Restless, Sad, Strong, Tired, etc. The user then selects, e.g., by pointing and clicking with a mouse, the emoticon which most closely matches his current emotional state. The system stores the identity of the selected emoticon. In that way, an emotional history of each user can be created over time.

Each emoticon preferably has an expression, a color and supporting text. The example emoticons in FIG. 3 have a broad range of facial expressions and the text is to support that expression in case of question. In one embodiment, the color is significant. For example, a yellow emoticon may be a “positive” emoticon; that is the person who selects it is feeling positive about themselves/life. An orange emoticon may be a neutral emoticon; that is the person who selects it is feeling just OK about themselves or life. A red emoticon may be a “negative” emoticon; the person who selects it is feeling negative about themselves or life. When the user selects an emoticon, the content module stores the selection and time of selection for use by other modules. In one embodiment, the content module causes the user's device to display the selected emoticon on the user's homepage. In another embodiment, the content module may display the most recently selected emoticon selected by each user next to their name on each friends list to which they belong. In that way, members of the community can quickly know the emotional status of their friends.

Different recovering patient groups may be presented with different sets of emoticons by the content module. For example, in one embodiment, a bulimic or anorexic recovery patient will be able to select a customized set of emoticons (including, for example, “I feel fat”) which differs from the set of emoticons made available to a recovering alcoholic patient. Similarly, a recovering drug/substance addict patient will have yet a different set of emoticons to choose from.

As a user accesses the site, preferably on a daily basis, he selects the emoticon(s) that best represents their current emotional state and each emoticon choice is logged. In one embodiment, when a user selects a red emoticon at login, the analysis module will immediately detect the selection and perform a recover assisting action such as sending a text message (or other type of communication) to the cell phones of all the friends on the friends list of the user that have been grouped as care givers or supporters of the user. In one embodiment another type of recovery supporting action that can be taken is the transmitting of a personalized message that has previously been selected or generated for the user. For example, the content module can prompt the user to identify or generate an encouraging message for later use. In one embodiment, the user can supply photographs having a strong positive emotional value, e.g., wedding photos or pictures of children. Alternatively, textual messages, sounds, videos, or other types of messages could also be provided. The content module can store the provided messages. Subsequently, when the analysis module determines that a recovery supporting action is appropriate, the analysis module or content module can retrieve the previously generated messages and provide them to the user. In an alternative embodiment, other users such as friends or life line users can also generate personalized messages through the content module for subsequent use. Advantageously, by generating personalized messages ahead of time, the platform can provide immediate, substantial support when needed.

It will be appreciated that while the emoticon selection process above uses emoticons representing emotional states, other types of information may also be collected in order to address certain conditions. For example, rather than tracking emotions to monitor addiction recovery, the modules of platform 12 can record and store a user's weight, calorie intake, blood glucose level, medication consumption, or other information. By tracking these additional categories of information, the platform can further enhance the recovery of conditions such as diabetes or hypertension. Again, while the collection of emotional state information may be described, this should not be interpreted as limiting the systems and methods herein to the treatment of addiction recovery. Rather, the systems and method described herein may be used to provide support for recovery of any condition including chronic conditions.

Over time, a profile of emotional states is collected by the content module. In one embodiment, this collection of emotional states is preferably managed by administrative module 34. Administrative module 34 preferably provides a “back-end” administrative section for the treatment center. The administrative module provides the interface for the clinical professionals associated with the community. In one example, each patient is assigned to a clinical professional that is provided access to the patient's account via the administrative module 34. For example, in administrative module 34, the emoticon choices can be displayed in an assessment form when called up by a clinical professional assigned to the user. All users belonging to that administrator who have had red emoticons within an administrator selected period will show as being worthy of additional attention.

Allowing a user to inform the site (and thus their friends and administrator) of their mental state via the emoticons provides support and diagnosis of the user's mental health. Additionally, the emoticon history of each user is analyzed by the analysis module 36 to predict their recovery behavior and anticipate a user who is developing potential recovery problems before even the user is aware of it coming. For example, in one embodiment, administrative module 34 may send information related to a patient to analysis module 36. After analyzing the collected patient information and determining a patient is likely to develop a recovery problem, analysis module 36 may alert friends (e.g., members of the life line category) and treatment center administrators of the patient's/user's condition. This will allow the site to provide rapid intervention via friends and administrators; another unique use of the emoticons. This type of intervention or other beneficial action may be referred to generally as a recovery supporting action. Similarly, with other status indicators, such as indicators relating to consumption of prescribed medication or food intake, friends and administrators can also intervene to facilitate recovery.

System 12 also preferably includes a privacy module 38. As is known, social networking sites allow the posting of content. Social networking sites also generally allow the poster of the content to restrict the viewing of such content to a group or friends as well as general viewing by all site users.

However, the present social networking site provides the benefit of allowing the patient/user and/or administrator to institute privacy settings based on content and viewers of that content. For example, in one embodiment, users can specify what information is visible and who can view it:

World: Anyone can view the user's content.

Members: Only registered members can view the user's content.

All Friends Only members who the user has approved as Friends in their network are able to view the user's content.

Family: The user's family members can view the user's content.

Life Line Members who are charged with providing a support network for the user.

Caregroup: When the user is charged with providing a support network for another member.

Me: The user is the only person who can view their content.

Privacy module 38 allows the user to expose a number of items on the site according to the restrictions listed above. For example, some items that may be posted on the site include a Profile, Story, Blog, First Name, Clock, Calendar, Goals, Post to Journal, and Profile Photo. As is appreciated, each individual item can be treated differently (World, Members, All Friends, Me) giving the user control over their privacy.

Additionally, in some embodiments, privacy module 38 allows the treatment center administrator to view all the users' data. This is a significant difference from any other social networking site as the administrator is a trusted third party due to their relationship with the users within their community.

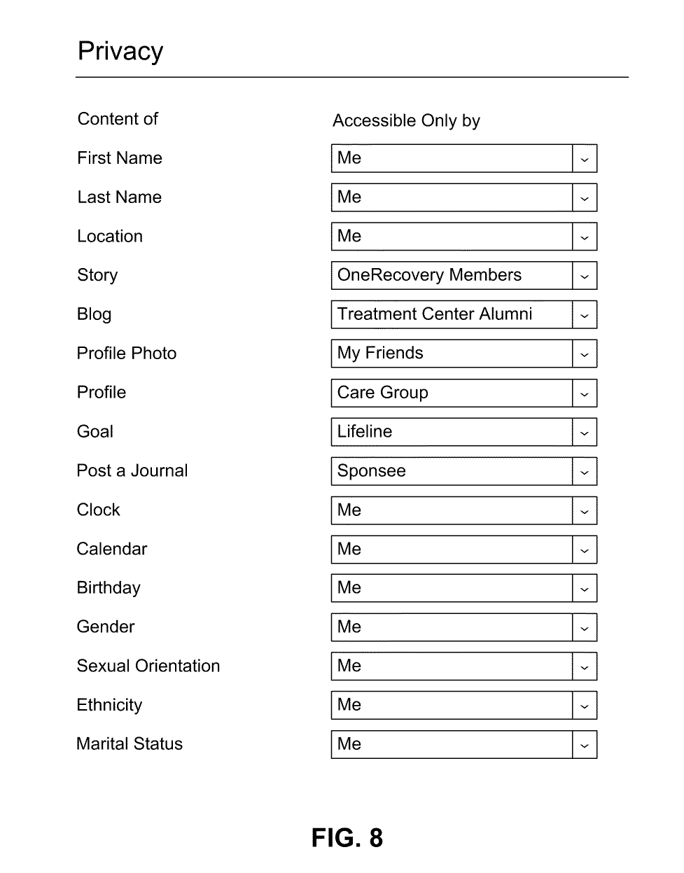

FIG. 8 illustrates one embodiment of privacy filtering using privacy module 38. As shown different aspects of the user's profile can be exposed to different groups of users and medical professionals.

Content module 40 preferably manages the information for items posted on the site such as the emoticons, Profile, Story, Blog, First Name, Clock, Calendar, Goals, Post to Journal, and Profile Photo. Collectively, the content on the site may be referred to as interactive content. In one embodiment, the user enters the information necessary to create a profile, for example and the content module 40 stores and makes available the profile to the web site. The content module 40 may receive and store the information posted by users.

Because the social networking site is for patients in recovery, it is common that some of the users will be monitored by clinical or health professionals. This monitoring may be performed in administrative module 34, as described above. For example, a user of the site who is in recovery may have a sponsor as well as support from their treatment center facility staff. The sponsor may be another person in recovery but with more experience and success in this area. The sponsor will support this user but is not a clinician and therefore may not have detailed insight in to their sponsee.

The staff of the treatment center, on the other hand are clinical professionals. By using the social networking site, the professionals can set goals in the account of the user and have the site assist in the monitoring and support of those goals. The user can report their progress towards accomplishing the goal in their account which is monitored by the professionals.

For example, in one embodiment, the user may set goals and submit updates regarding each of the goals in the content module 40. Such goals may include, for example, getting a sponsor for a support group (e.g., a sponsor for Alcoholics Anonymous), attending a support group meeting, hitting a milestone of so many days substance-free, etc. In another embodiment, the platform may automatically generate goals for the user.

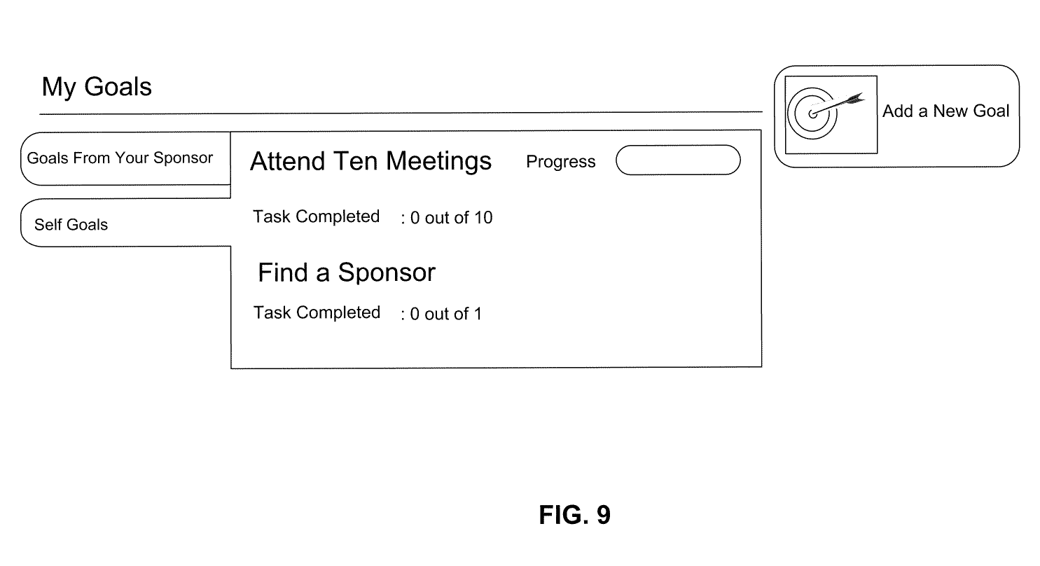

FIG. 9 illustrates the display of goals and goal tracking according to an embodiment. As shown, each goal and the user's progress in completing the goal are shown. Further, goals set by the user for himself or herself are separated from goals set for the user by a sponsor or health professional.

The content module 40 may, in some embodiments, share the information or transfer the information to administrative module 34 for management or assessment. A clinical professional or administrator may look for patterns or parse the data received from content module 40 to determine how a patient is performing in his recovery.

Additionally, the content module 40 can transfer or share site activity information and content with the analysis module 36 which applies heuristics to the data to identify how a patient is doing, e.g., using a Bayesian inference algorithm. Further, as the set of data grows, the system can learn to more accurately identify patients in trouble or heading for trouble. For a patient exhibiting patterns or raising red flags there that may be a recovery problem, administrative module 34 can send information related to the patient to analysis module 36. Analysis module 36 may then alert friends and treatment center administrators of the patient's/user's condition.

In one embodiment the events and activities of the patients on the web site are individually captured and stored in a database such as database 80 in FIG. 1 where they can be accessed by the analysis module 36. Each event offers an insight in to how the user is actually feeling at a given moment. Gathering the long-term data will allow us to observe each site user (patient) over time. This data is translated into understanding how a user is feeling and allows the site to become aware if a user is heading in a direction that will affect their recovery.

In one embodiment the data analysis on the site is achieved by use of a Bayesian inference algorithm included in the analysis module 36. Bayesian inference involves the collection of evidence that is meant to be consistent or inconsistent with a given hypothesis. As evidence accumulates, the degree of belief in a hypothesis ought to change. With enough evidence, it should become very high or very low. Thus Bayesian inference can be used to discriminate between conflicting hypotheses: hypotheses with very high support should be accepted as true and those with very low support should be rejected as false.

The Bayesian inference algorithm used by the analysis module to analyze a given user learns their behavior over time. For example, it is possible that a user who occasionally posted to a forum changes their frequency and publishes more or less often is experiencing some event in their life to cause this change. Alternatively it could be that the user is simply changing their behavior for no reason at all. Thus as a single point of information, this data is not very useful. However, the algorithm looks at all aspects of the user on the site and can predict a trend if there are several changes that happen at once or over a relatively short period of time.

As an example, a user begins to post less often in their private Journal but more frequently in their Blog, Wall and on the Forums provided by the site. This user appears to be increasing their social interaction on the site but at the same time neglecting a very important part of recovery, the personal introspection provided by their private Journal. This user may well be reaching out for help or, alternatively, is strongly in recovery and feels less need for introspection. The analysis module can perform recovery supportive actions such as generating a message to the appropriate treatment center administrator know of the changes in behavior and they can reach out to the site user to verify how they are feeling. The administrator can then inform the site (this particular algorithm works best with a closed loop analysis) of the actual state of that user. Over time, the algorithm will accumulate knowledge to allow it an accurate view of change as reflected by real data. Additionally, data is collected from treatment professionals when adverse events or lapses in recovery occur to improve the algorithm. The algorithm will then be better able to predict with significant accuracy the probable outcome for each user based on their site use.

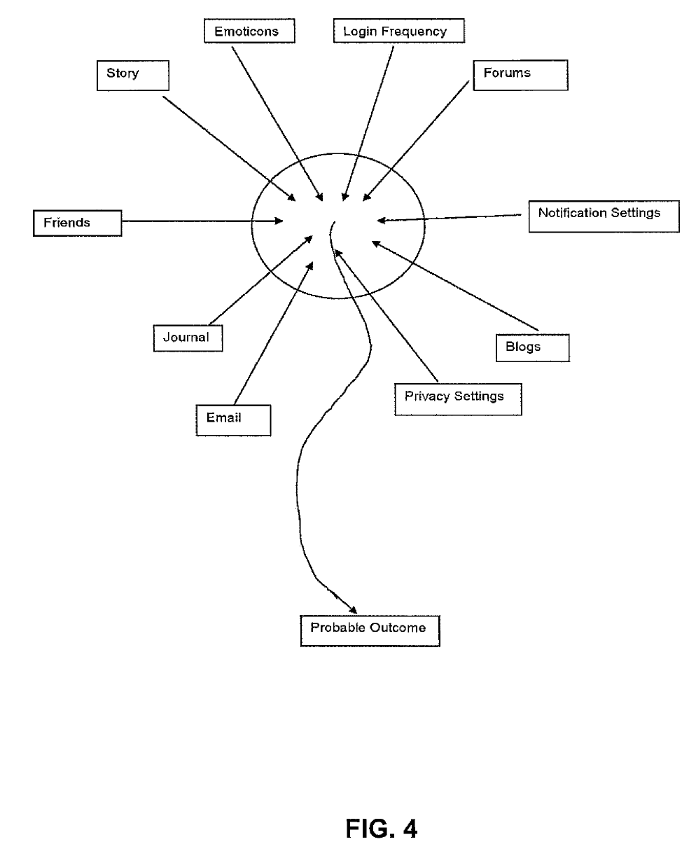

FIG. 4 is a graphical representation of information that is fed in to the algorithm. Each element creates a pool of data that is tracked over time. Emerging from the algorithm is a probable outcome for a given user based upon the data they have created by their use of the system.

Each data element fed into the algorithm will have a different weight in the algorithm. This is because each element is driven by a real world use of the site and some elements, by the nature, will be used more frequently than others. Thus changes to one of the least used elements may actually be more significant than changes to the most used elements. For example, changes to the Privacy Settings, something done quite rarely, may be more of an indicator than, say, changes to their email habits.

Examples of initial site element weightings are as follows:

1) Emoticon history

2) Friend changes

3) Privacy settings

4) Notification settings

5) Login frequency

6) Email use

7) Blog use

8) Forum use

9) Journal use

10) Story use

The algorithm works down this list building the probable state of the user. As an example, should the user not change their emoticon status much over time, but change their Friend, Privacy and email use then this is an indication of a trend which the algorithm can use to establish Probable Outcome. The more elements that change the greater the reliability of the Probable Outcome, of course, but the algorithm can function with as three or fewer elements.

Each element has, of course, three states of change. An increase, a decrease and no change. Depending on the element and upon other elements these changes may or may not have any significance in the prediction of the state of a user.

Should a user add more friends than usual remove more friends than usual or leave the number of friends the same but make no other changes to their use of the site then this single data point is meaningless. It would appear obvious that a decrease in, for example, Forum use might indicate a negative trend on the part of the user however it can be argued that an increase in Forum use might indicate a negative trend as they are reaching out for help. This clearly indicates that the single element change is not useful information on its own.

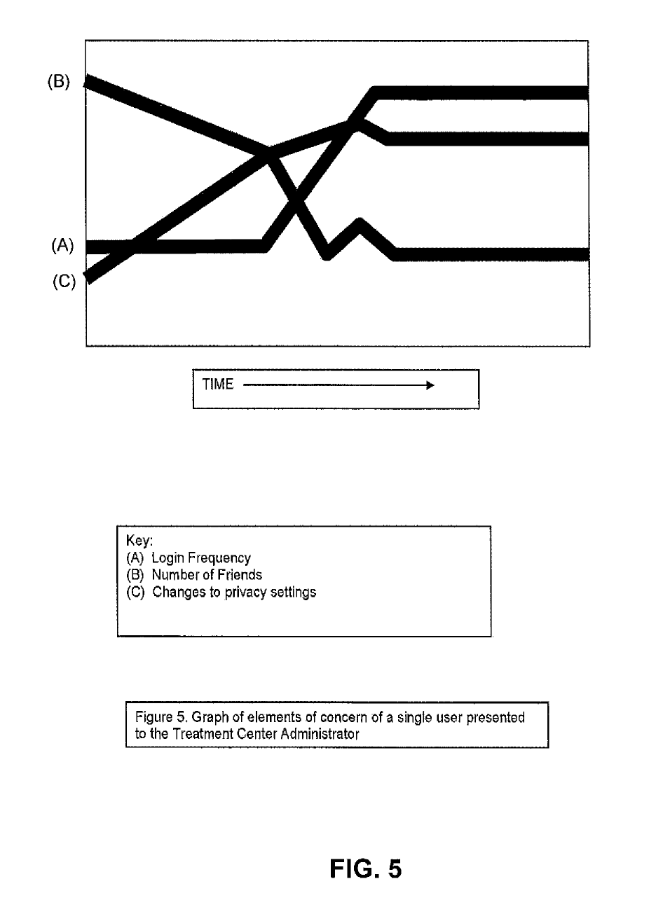

The algorithm, in finding an element where the trend may indicate a source of concern, will then progress down the list looking for other elements that are also indicating a potential source of concern. In this example, once three or more elements are found indicating a trend, then the trend is analyzed for Probable Outcome and the Treatment Center administrator is notified by email or similar means. A graphical display of the elements in question is presented to the Treatment Center administrator once they log in to the administrator area of the site. FIG. 5 is an example of a graphical presentation of the information for an administrator.

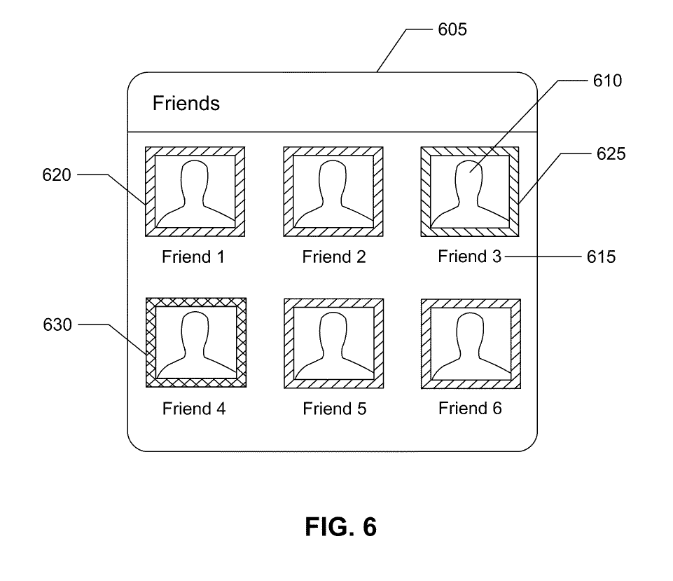

FIG. 6 is an illustration of auras or color frames according to an embodiment. The functionality of the auras described herein may be accomplished by the content module described above in FIG. 2. As described, each user may periodically select an emoticon representing, for example, an emotional state. Further, each emoticon or groups of emoticons is associated by the content module with a color or other level indication. Advantageously, by mapping each emoticon to a color, e.g., red (bad), yellow (neutral), or green (good), the content module simplifies a relatively large number of emoticons into a smaller number of levels indicative of status. The content module may accomplish this mapping, for example, by storing a table or pairs of values that associate particular emoticons with particular auras. In one embodiment, the color levels associated with the various emoticons are referred to as auras. FIG. 6 illustrates the display of auras to quickly convey the status of users to other users in the visual display of the system. As illustrated, in one embodiment, when accessing the social network, the content module 40 displays a window 605 showing images 610 and names 615 associated with one or more other users (e.g., friends, supporters, family, etc.). In addition, each image 610 may have an associated aura 620, 625, and 630. The aura is visible to other users across the platform and is a quick visual indicator of the emotional status of members. For example, the aura 620 may be red, corresponding to emoticons associated with the red level. Aura 625 may be yellow, corresponding to emoticons associated with the yellow level. Aura 630 may be green, corresponding to emoticons associated with the green level. It will be appreciated that other colors may be used for auras. In addition, more or fewer levels could be used for auras. Similarly, auras may be images, sounds, text or other indicators of emoticon level. Users can also have the content module filter their friends and subgroups of users by these auras to quickly identify those users who are in need of support. Likewise, administrators can have the content module filter their alumni by these auras to quickly identify those users who are in need of support.

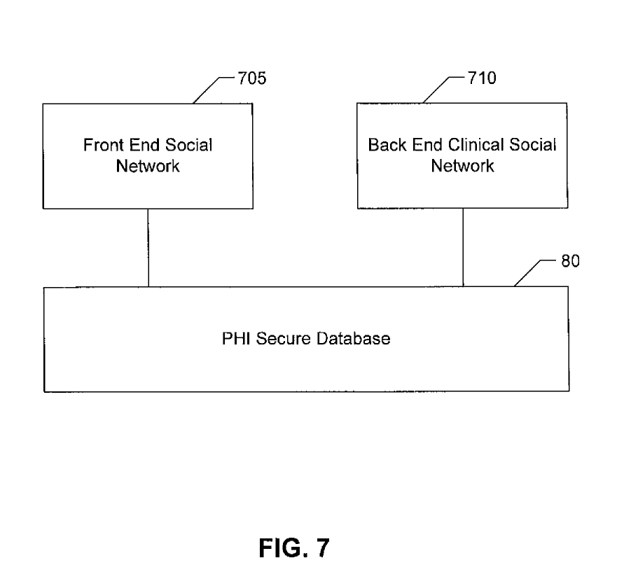

FIG. 7 is a logical block diagram of an example system according to an embodiment. As described above, the privacy module allows a user to select groups of individuals that are able to view information about and generated by the user. The data generated by the user through interaction with the interactive content on the platform, e.g., emoticon selection, journal entries, blog posts, or the recovery clock, may be stored in the database 80 by the content module 40. In one embodiment, the information provided in this manner through the front end social network 705 by the user can be considered non-private health information. As described above, this non-private information may be analyzed by other users, health professionals, or automatically by the analysis module in order to determine and perform recovery supporting actions. However, in addition, it may be beneficial to utilize additional, private health information to provide better analysis and more complete information to health care professionals. This private information may comprise information covered under the Health Information Privacy Act (HIPA) that requires certain privacy protections. Accordingly, a HIPA compliant back end clinical social network 710 can be provided. The functionality of the back end network may be provided by the administrative module as described above. In one embodiment, private health care information for users may be entered, maintained, and analyzed by associated health professionals through the back end clinical social network 710. In one embodiment, the private health care information entered through the back end clinical social network may be stored in a separate portion of the database 80. In another embodiment, the private healthcare information may be stored in a separate database (not shown). Advantageously, in some embodiments, non private healthcare information from the front end social network 705 may be transferred to the back end clinical social network 710. In this manner, healthcare professionals can monitor users and perform recovery supporting actions based on a greater body of information about the user. Further, while private health information itself is not transferred from the back end network 710 to the front end network 705, the user's experience in the front end network may be adapted based on the private data from the backend network 710. For example, the interactive content may automatically be adjusted based on information from the back end network 710.

Advantageously, the combination of the front and back end networks with transfer of non-private data between them to enhance the value of each side. For example, social activity facilitated by the content module on the front end creates data for the administrative module on the backend side that makes provide risk/outcome data. In addition, clinical outcomes in the backend provides data to the front end that may modify users' experience, goals, and recommended features that lead to positive behavioral change. In one embodiment, the control of access to content described above in conjunction with FIG. 8 can be extended from the front-end member facing social network to the back-end portion of the platform and may allow multiple levels of access to information based upon the user role/group on the back-end of the platform.

In another advantageous aspect, the data accumulated through the back end 710 can be made anonymous by the administrative module and then used for statistical analysis and performance evaluation by different healthcare providers, end users, and insurance companies. For example, the administrative module allows treatment centers and insurance companies to view relative and anonymous data to compare other treatment center and insurance companies to determine comparable outcomes. The anonymous data may include data gathered form interactions of multiple users with the interactive content on the platform such as recovery clock.

In one embodiment, administrators of a clinic can view relative data from other treatment centers through the administrative module to compare their outcomes against other treatment centers. All other data from other treatment centers will be stripped of any private health information or any other identifiable information. In another embodiment, end users can compare treatment centers to compare against a set of personalized data to compare treatment centers and evaluate outcomes. A user can select from a geographical location, a price range and size of treatment facility to compare outcomes among treatment centers. In another embodiment, an insurance company may compare treatment centers to identify which centers provide the highest outcomes across one of its user segmented groups.

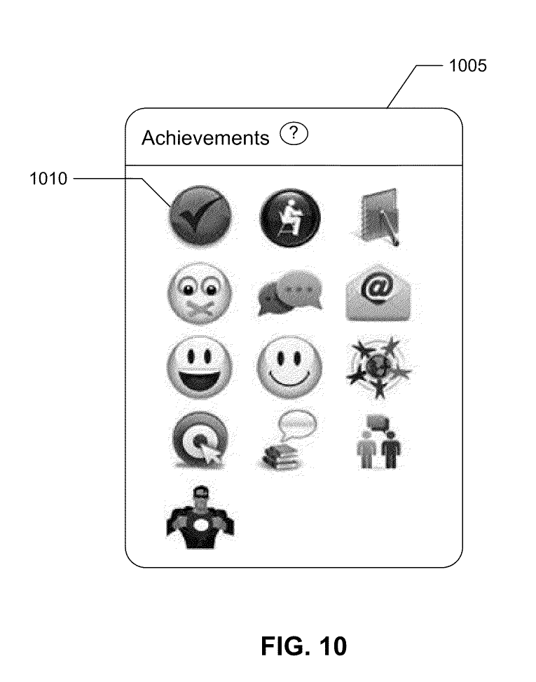

FIG. 10 is an illustration of the display of achievements according to an embodiment. In one embodiment achievements are provided through the content module. In addition to being able to set and track individual goals, users can be encouraged to engage in activities that award them achievements for completing activities on the site. These activities can be based on things the user can do on the site that also supports the user's recovery. These achievements are based off of clinical data and can be applied to not only addiction recovery but to recovery from various conditions. The achievements may have multiple levels by which the user will unlock and move up their ranking as they progress. As the user unlocks all of the achievements for a given level, they will move to the next level to find a new set of achievements. The game mechanics behind the achievements work based on the elements of, action, tasks, scoreboard and reward. The achievements are not only for members of the front-end member facing social network, but may be altered to work with the back-end portion of the platform described in FIG. 7. As illustrated, when accessing the platform, the content module displays a window 1005 comprising representations 1010 of various achievements. Examples of achievements include: inviting new members to participate in the platform, writing a journal entry, posting to a blog, and chatting with other users. The content module monitors a user's interaction with the content of the platform in order to determine the user's progress in completing the achievements. The content module can also display the user's progress in completing the achievements. Advantageously, achievements can encourage users to participate in the community users and thereby encourage recovery.

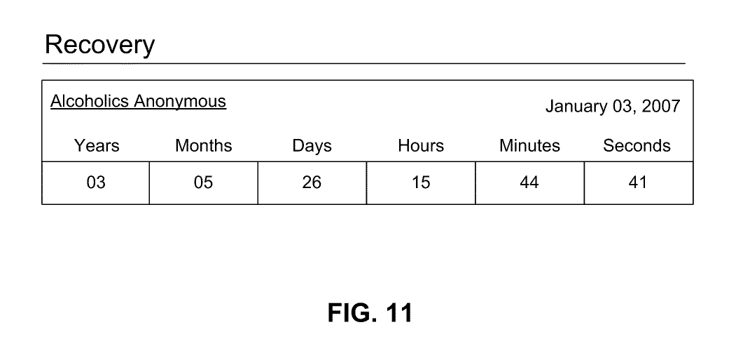

FIG. 11 is an illustration of a recovery clock according to an embodiment. In one embodiment, the recovery clock is provided and managed by the content module. In one embodiment, a user can create a recovery clock based upon a recovery program associated with the user, e.g., Alcoholics Anonymous or Narcotics Anonymous. This recovery clock counts up from the given date, e.g., a sobriety date. Advantageously, presenting the user with the clock can provide emotional support and encouragement in recovery. Further, in some embodiments, the recovery clock can be shared with other users or healthcare professionals through the content module or administrative module. These other individuals can then offer support and encouragement. It will be appreciated that while the recovery clock has been described in relation to recovery associated with addition, the recovery clock can be used to enhance recovery from other conditions as well. For example, the recovery clock can track an amount of time for which a user has taken prescribed medication, eaten in a healthy manner, exercised, or performed other actions related to recovery. Accordingly, the recovery clock should not be interpreted as being limited to addiction recovery.

In one embodiment, users can have their clock “verified” by another user, by a healthcare professional, or by automated correspondence generated by the content module or administrative module. For example, when the user reaches a milestone (30 days, 60 days, 90 days, 6 months, 1 year etc) the user will verify that their recovery clock is correct and they are continuing with their recovery. For example, the user may respond to a message automatically generated by the content module when a milestone is reached. By requiring verification of the accuracy of the clock, the system can better ensure that a user has achieved the indicated milestone. Reaching milestones may also trigger recovery supporting actions such as the awarding of an achievement, notification to other users, or presentation of a congratulatory message.

In one embodiment, the user may reset the recovery clock in the case of a relapse. This may be accomplished by communication through the content module. When the clock is reset, the date will reset to the current date and the clock will begin to count up again. Providing the opportunity to reset the clock can offer a beneficial effect to the recovery of the user. Further, the reset of the clock can be used as a trigger for recovery supporting actions such as notifying the user's their friends/support network/medical professionals via email/sms/site messages urging them to support the user.

In addition, the use of a recovery clock can be used to accurately track the performance of users who participate on the platform. For example, the analysis or administrative modules may track a user's performance via the recovery clock. Recovery performance has been notoriously difficult to monitor. For example, performance in addiction recovery has sometimes been monitored by periodic phone calls. However, these phone calls may not be returned and may not otherwise provide accurate information. However, by recording the status of a user's recovery clock, the modules of the platform can accurately determine a significant factor in recovery performance.

In another embodiment, the administrative module may encourage experienced users of the platform to interact with and support new users. In one embodiment, the administrative module may pair a new user with an experienced user. The experienced user may be referred to as an ambassador. In order to generate the pair, the administrative module analyzes factors such as, but not limited to, recovery program, location, gender, and age. After considering the factors for both the new and experienced users, the administrative module can determine a pair. To provide encouragement, the administrative module may give the ambassador one or more tasks to perform with respect to the new user. These tasks may include:

1. Welcome the new user to the site with wall post

2. Request friend of new user—introduce them as their Recovery Ambassador

3. 1:1 chat to say hi and talk to new user

4. Encourage new user to fill out profile and upload profile picture

5. Introduce new user to 3 other members and have them request friendship

6. Encourage new user to write their story

7. Encourage new user to write down a few goals for themselves

8. take new user into group chat and introduce them to the people in chat

9. Encourage new user to write a new blog and introduce themselves

10. Take the new user to a meeting

By arranging an ambassador for new users, the recover prospect for the new user may be improved. Further, the experience and recovery of the users participating in the ambassador program may be enhanced.

In another embodiment, the recovery platform may make use of mobile technology in order to facilitate and improve recovery outcomes. In one embodiment, location based services (“LBS”) for health care related functions can be used in conjunction with the platform. For example, users will “check in” via mobile phones or other device access with GPS. With reference to FIG. 1, checking can comprise a process where a user device, such as the devices 10 or 11, transmits location information to the host device 16 through the network 100. In one embodiment, the home page provided by the platform may have a button or link that causes the user device to send location information to the hosting device when selected. Alternatively, an application running on the user device may provide a button or link which causes the application to provide the location information. In either case, once the check in functionality is activated, the location information is then transferred to the host device 16 and to the application device 12 for use by its modules. This mobile check in can be used to enhance the likelihood of attending meetings, doctor visits, clinic workshops, or the gym. For example, the administrative module may share check in information with other users and medical professionals through the platform by way of messages/email/SMS. In one embodiment, the user check in function can be used to support the completion of goals. For example, to achieve the goal of attending 10 meetings, a user can use the mobile check each time he or she attends. The content module can then track the progress. By using location based technology, the accuracy of such tracking can be improved.

In another embodiment, location based services can be used to provide timely assistance to users in need. For example, the check in functionality described above may have an associated “panic button” for indicating immediate need. The administrative module can receive the panic signal and notify other users so that the users can offer support. For example, a recovering alcoholic may need immediate help when passing by a bar. Alternatively, a user recovering from diabetes may need help when going out to dinner. The user can activate the panic button. The administrative module can then contact other users that have been previously identified by the user as panic signal recipients. In one embodiment, the location of the user in need can also be sent by the administration module to nearby friends so that they can intervene in person.

In another embodiment, the administration module allows healthcare administrators such as treatment center administrators to build a customized discharge plan for each user as they are leaving treatment. A customized discharge plan may include, among other things, a set of goals that can be tracked through the platform in order to monitor progress. In this manner, rather than providing a discharged patient with paperwork that may be lost or discarded, the medical professional can ensure that the customized discharge plan is always available to the user and can accurately follow the user's progress. In one embodiment, the administrative module presents a template discharge plan with certain options and features to medical professionals. The medical professionals can select other features and options based on the particular patient. The discharge plan is then made available to the user through the content module.

In another embodiment, in order to maintain order and avoid harassment within the community platform administrators may occasionally remove users from the site. Traditionally, this would result in the removal of their profile and restrict them from logging into the platform. However, in another embodiment, instead of eliminating the offending user's profile and access administrators can mark the account to be invisible to other users. Marking the account as invisible causes the logon module to allow the offending user to log into the platform, read/view content and to post comments and create content. However all communications and interactions of the offending user to with the platform are visible to only the offending user. The content module prevents all others users on the site from being able to view the content created by the invisible user. In this manner, the sense of community can be maintained without entirely cutting off the offending user from access to the recover assisting tools available on the platform.

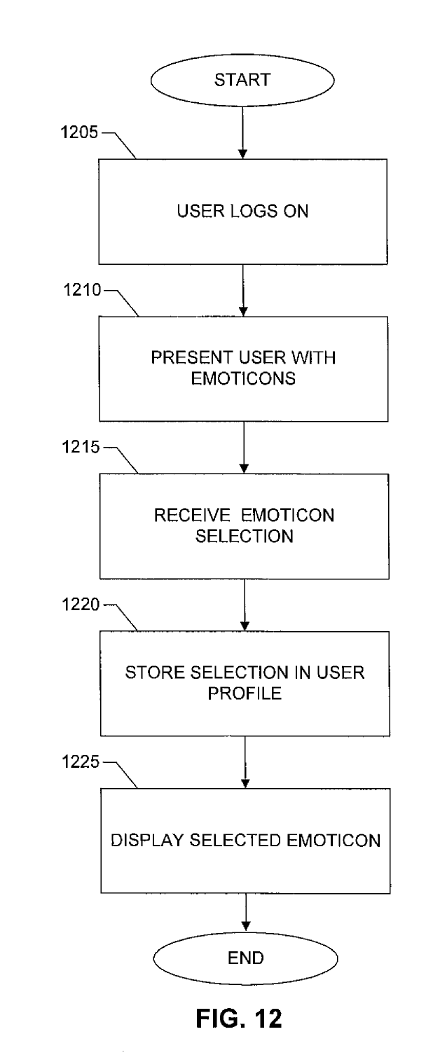

FIG. 12 is a flowchart illustrating a method of using emoticons according to an embodiment. It will be appreciated that while emoticons are described, the present method may be implemented using other status indicators as well. In one embodiment, the method may be implemented by the system 12 of FIG. 2. As illustrated, at step 1205 a user logs on to the platform. As described above, logging on may be accomplished in conjunction with the logon module of FIG. 1. For example, in order to facilitate logging on, the platform may establish a communication link with a user device associated with the user. The communication link may be, in part, the Internet or a cellular network that provides data communication services. At step 1210 the user is presented with one or more emoticons or other status indicators. The emoticons may comprise, for example, images as shown in FIG. 3, one or more textual characters, or a sound. In addition, one or more of the emoticons presented to the user may correspond to the condition associated with the user. For example, if the user is recovering from addiction, the presented emoticons may include emoticons associated with craving. Alternatively, if the user is recovering from diabetes, the presented emoticons may include emoticons associated with faintness.

Continuing at step 1215, the platform receives an indication of the emoticon selected by the user. In some embodiments, after receiving an indication of the selected emoticon, the platform may send an indication of the selected emoticon to one or more users or healthcare professionals. At step 1220, the user's selection is stored in the user's profile along with a history of the previously selected emoticons. In one embodiment, based on the selected emoticon alone or in conjunction with the other emoticons previously selected, the platform may also determine a recovery supporting action to perform. The actions may include notifying other users of healthcare professionals that the user needs support, providing an encouraging message, video, or audio clip to the user, or other action. The recovery supporting action may be performed by the administrative module as described above. At step 1225, the selected emoticon is displayed to the user. As described above, after receiving an indication of the selected emoticon, the platform may determine a corresponding aura and display the aura to other users or healthcare professionals. Advantageously, the use of emoticons can lead to immediate support for users. In addition, by tracking emoticons over time can lead to detection of support needs by determining changes in patterns.

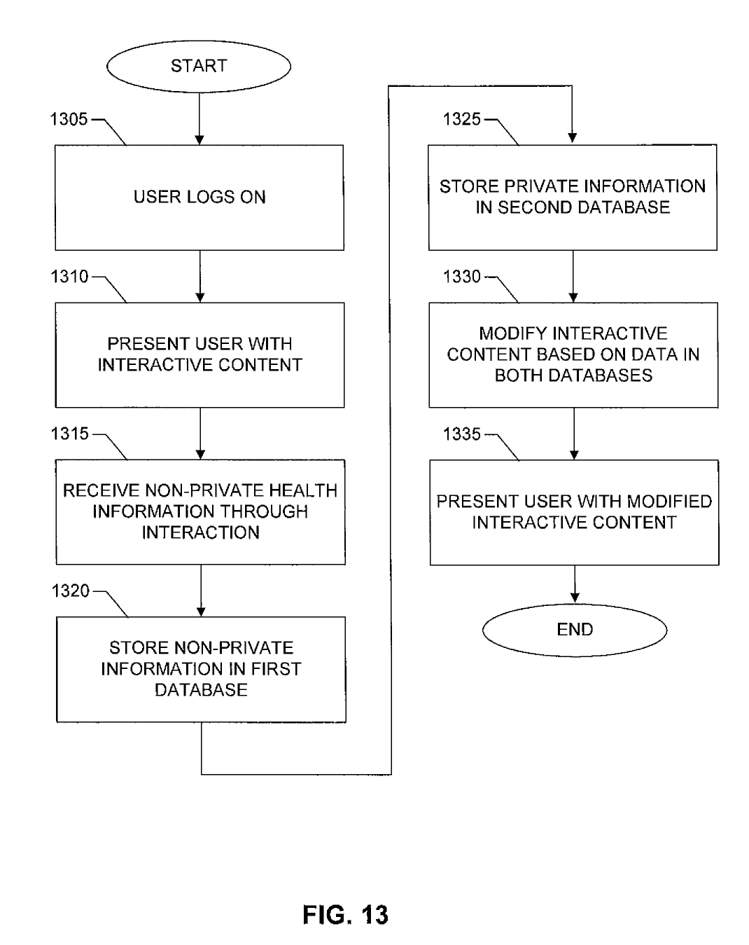

FIG. 13 is a flowchart illustrating a method of handling user information according to an embodiment. In one embodiment, the method may be implemented by the system 12 of FIG. 2. At step 1305 a user log on to the platform, as described above, logging on may be accomplished in conjunction with the logon module of FIG. 1. For example, in order to facilitate logging on, the platform may establish a communication link with a user device associated with the user. The communication link may be, in part, the Internet or a cellular network that provides data communication services. At step 1310, the platform presents the user with interactive content. This may be accomplished by the content module. As described above the interactive content may comprise selection of emoticons, blogs, recovery clocks, calendars, goals, achievements, journal, and other social networking features. At step 1315, the platform receives data indicative of non-private health information for the user through the user's interaction with the interactive content. For example, the user's selection of an emoticon can be treated as non-private health information. Similarly, other aspects of the user's interactions such as the factors described above with respect to FIG. 4 may be treated as non-private health information.

Continuing at step 1320, the platform stores the received non-private data in a first database. At step 1325, the platform stores private health information for the user in a second database. Steps 1320 and 1325 may be accomplished as described above with respect to FIG. 7. At step 1330, the platform modifies the interactive content for the user data based on data in both the first and second databases. For example, the platform may provide the user with encouraging messages based on the data in the two databases or may set new goals for the user. At step 1335, the platform presents the user with the modified interactive content. Advantageously, by providing a secure way to analyze non-private and private health information for a user, the recovery outcomes for the user can be greatly improved without compromising confidentiality.

Those of skill in the art will appreciate that the various illustrative modules, engines, and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules, engines, and method steps described in connection with the embodiments disclosed herein can be implemented or performed with computer hardware including a general purpose hardware processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

What is claimed is:

1. A system for recovery based social networking, the system comprising:
a logon module configured to authorize a user to access a recovery based social network;
a content module configured to
present interactive content to the user,
receive input from the user responsive to the interactive content,
store the input from the user; and
a privacy module configured to restrict access to a first portion of the input to a first user selected group.

2. The system of claim 1, wherein the first user selected group comprises friends, family, lifeline, caregroup, or only the user.

3. The system of claim 1, wherein the privacy module is further configured to restrict access to a second portion of the input to a second user selected group.

4. The system of claim 1, further comprising an analysis module configured to:
determine, based at least in part on the input, a recovery supporting action; and
perform the recovery supporting action.

5. The system of claim 4, wherein the recovery supporting action comprises sending an alert message to a second user selected group.

6. The system of claim 1, further comprising an administrative module configured to:
store private health information for the user; and
present a portion of the input and of the private health information to a healthcare professional associated with the user.

7. The system of claim 6, wherein the privacy module is configured to restrict access to the private health information to all users except the healthcare professional.

8. A method for recovery based social networking, the method comprising:
establishing a communication link with a user device associated with a user;
presenting, via the communication link, interactive content to the user device,
receiving, via the communication link, input from the user device responsive to the interactive content;
storing the input from the user; and
restricting access to a first portion of the input to a first user selected group.

9. The method of claim 81, wherein the first and second user selected groups comprise friends, family, lifeline, caregroup, or only the user.

10. The method of claim 8, further comprising restricting access to a second portion of the input to a second user selected group.

11. The method of claim 8, further comprising:
determining, based at least in part on the input, a recovery supporting action; and
performing the recovery supporting action.

12. The method of claim 11, wherein the recovery supporting action comprises sending an alert message to a third user selected group.

13. The method of claim 8, further comprising:
storing private health information for the user; and
presenting a portion of the of input and of the private health information to a healthcare professional associated with the user.

14. The method of claim 13, further comprising restricting access restrict access to the private health information to all users except the healthcare professional.

15. A computerized method for supporting addiction recovery, the method comprising:
establishing a communication link with a user device associated with a user;
presenting, via the communication link, interactive content to the user device related to recovery from addiction;
receiving, via the communication link, non-private health information from the user device comprising the user's interaction with the interactive content;
storing the non-private health information in a first database;
storing private health information associated with the user in a second database;
modifying the interactive content based, at least in part, on the private health information in the second database and the non-private health information from the first database, wherein modifying the interactive content does not expose private health information from the second database; and
presenting, via the communication link, the modified interactive content to the user device.

16. The method of claim 15, further comprising transferring the non-private health information from the first database to the second database.

17. The method of claim 15, wherein the first and second databases are separate portions of a same database.

18. The method of claim 15, further comprising restricting access to the non-private health information associated with the user based on user specified preferences.

19. The method of claim 18, wherein the user specified preferences comprise indications of particular groups of users that can access different portions of the non-private health information.

20. The method of claim 15, further comprising providing access to a portion of the private health information and of the non-private health information associated with the user to a healthcare professional associated with the user.
